(19) United States
(12) Patent Application Publication
(10) Pub. No.: US 2015/0227911 A1
(43) Pub. Date: Aug. 13, 2015

(54) Method and System for Executing a Financial Transaction

(71) Applicant: Tobias PFÜTZE, Welzheim (DE)

(72) Inventor: Tobias Pfütze, Welzheim (DE)

(21) Appl. No.: 14/421,957

(22) PCT Filed: Aug. 19, 2013
(86) PCT No.: PCT/EP2013/067255

§ 371 Date: Feb. 16, 2015

(30) Foreign Application Priority Data
Aug. 20, 2012 (DE) 10 2012 214 744.6

(51) Int. Cl. G06Q 20/32; G06Q 20/40

(52) U.S. Cl. CPC G06Q 20/322; G06Q 20/4012; G06Q 2220/00

(57) ABSTRACT

In a method for executing a financial transaction by a financial service provider, a mobile customer device and a mobile or stationary dealer system are connected to a management server of a financial service provider system by means of a communication network. After the dealer system and the customer device have been registered and an identification number assigned to the customer device has been input, the dealer system sends transaction data to the financial service provider system, which produces a unique transaction code by means of a random generator and sends the unique transaction code to the dealer system. The customer must input the unique transaction code into the customer device. After the transaction data transmitted by the dealer system have been checked and confirmed by the customer, the financial transaction is executed and a notice of the successful execution of the transaction is sent to the customer device and the dealer system.

The invention relates to a method and a system for executing a financial transaction by a financial service provider according to the generic part of claims 1 and 14.

From US 2009/0094123 A1 there is known a method for executing a financial transaction between a customer and a dealer, in which a customer device, which consists of a mobile phone or a smartphone (Personal Digital Assistant—PDA), and a dealer device, which consists of a mobile phone, a smartphone or a point-of-sale terminal (POS terminal) with peripheral devices such as barcode reader, magnetic stripe reader, memory, printer, a near field communication (NFC), exchange data with a personalized payment system via a communication network. For determining the transaction, transaction data are entered into the dealer device, which data contain an identification of the products desired by the customer and their purchase price, which are gathered for example by means of a barcode scanner, possibly a product description, a subtotal and a final amount stating the value added tax. In addition, the transaction data can include the identification numbers of the dealer device, of the customer device and a unique identification character. After the customer has communicated the telephone number of his customer device to the dealer, the transaction data are transmitted from the dealer device to the customer device. With his customer device, by using the transaction data received from the dealer device, the customer subsequently directs a request to the payment system to execute the transaction, so that the transaction amount is transferred from his customer account to the dealer account. After the payment system has output a confirmation to the dealer device that the amount has been transferred, the dealer hands the purchased products over to the customer in order to complete the transaction.

When the dealer and customer devices are equipped accordingly, the transaction information instead of a communication of the telephone number or another identification of the customer device to the dealer, can alternatively be transmitted from the dealer device to the customer device by means of near field communication (NFC) or from the dealer device to the payment system which forwards the transaction data to the customer device.

The unique identification character, which in the known method possibly is contained in the transaction data, or the reference number for the transaction, which leads to an increased safety of the financial transaction, however, is generated by the dealer device and hence by a party involved in the transaction. In addition, the telephone number or another unambiguous identification of the customer device is required for the transmission of the transaction data from the dealer device to the customer device. These data can, however, improperly be obtained and used by third parties.

It is the object underlying the present invention to indicate a method for executing a financial transaction by a financial service provider, in which by using a mobile communication device on the part of the customer and a mobile or stationary communication system on the part of the dealer a maximum of safety is ensured during data transmission and in particular no improperly usable sensible data are exchanged between the mobile communication device of the customer and the mobile or stationary communication system of the dealer.

In accordance with the invention, this object is solved with the features of claim 1.

The solution according to the invention ensures a maximum of safety during the data transmission between a mobile communication device of a customer and a mobile or stationary communication system of a dealer and avoids the exchange and the transmission of sensible data for executing a financial transaction by a financial service provider system.

Correspondingly, for executing the financial transaction by the financial service provider system
a mobile customer device and a mobile or stationary dealer system are connected with a management server in the financial service provider system via a communication network,
the dealer system is registered in the financial service provider system,
an identification number (PIN) assigned to the customer device by the financial service provider system is entered into the customer device and the identification number is checked by the financial service provider system,
transaction data and an authorization request for the transaction are transmitted from the dealer system to the management server in the financial service provider system,
a transaction character is generated by a random generator connected with the management server and sent to the dealer system,
a request to enter the transaction character sent to the dealer system into the customer device is transmitted from the financial service provider system to the customer device, and
the transaction character entered into the customer device is checked after sending the same to the management server and the transaction data are transmitted to the customer device for checking and approval.

In contrast to the prior art, the singular transaction character is not dependent on a sequence of data from the transaction process, but is output as singular character string by a random generator which in particular is provided only for the dealer involved in the transaction. In addition, the singular transaction character is not generated by the dealer system, but by the management server of the independent financial service provider system and transmitted to the dealer system, so that after entry of the transaction character serving for identification into the financial service provider system of the party to be identified, the parties involved in the financial transaction are fixed unambiguously.

For merging dealer and customer or dealer system and customer device and for localizing the customer, the following method steps are carried out:
entry of an identification number (PIN) assigned to the customer device by the financial service provider system into the customer device,
connecting the customer device with the financial service provider system after successfully checking the identification number assigned to the customer device,
selection of a dealer from a list of proposed dealers of the financial service provider system or confirmation of a dealer proposed by the financial service provider system by the customer,
transmission of an authorization request for the transaction from the dealer system to the management server in the financial service provider system,
generation of a singular transaction character by a random generator connected with the management server in the financial service provider system and sending the singular transaction character to the dealer system,
sending a request to the customer device to enter the transaction character sent to the dealer system into the customer device,
entry of the transaction character into the customer device and sending the transaction character to the management server,
checking the transaction character sent from the customer device to the management server,
sending the transaction data to the customer device,
confirmation of the transaction data by the customer,
checking the correspondence of the transaction data confirmed by the customer with the transaction data transmitted by the dealer to the financial service provider system,
execution of the transaction by the financial service provider after successfully checking the correspondence of the transaction data entered by the dealer and the customer and sending a message on the successful execution of the transaction to the customer device and the dealer system.

Alternatively, the financial transaction comprises the following steps:
entry of an identification number assigned to the customer device by the financial service provider system into the customer device,
selection of a payment method on the dealer system by the customer,
transmission of an authorization request for the transaction from the dealer system to the management server in the financial service provider system,
generation of a singular transaction character by the random generator connected with the management server in the financial service provider system and sending the singular transaction character to the dealer system,
representation of the transaction character in complex in conjunction with an identification character of the dealer system,
entry or scanning of the transaction character and the unambiguous dealer system ID by the customer into the customer device and transmission of the transaction character to the management server,
checking the transaction character sent from the customer device to the management server,
sending the transaction data to the customer device,
confirmation of the transaction data by the customer,
checking the correspondence of the transaction data confirmed by the customer with the transaction data communicated by the dealer to the financial service provider system,
execution of the transaction by the financial service provider after successfully checking the correspondence of the transaction data entered by the dealer and the customer and sending a message on the successful execution of the transaction to the customer device and the dealer system.

To enable the customer and the dealer to utilize the advantages of a possible offline transaction, the dealer can offer an express checkout to the customer, in which the financial transaction is enabled at a later point in time and up to this time is blocked in the customer device, while the dealer system still communicates with the system of the financial service provider.

For merging dealer and customer or dealer system and customer device and for identifying the customer in the case of an offline transaction, the following method steps can alternatively be carried out:
entry of a customer device identification number assigned to the customer device by the financial service provider system into the customer device,
the management server of the financial service provider system assigns a static or dynamic identification number to the customer device—the transaction identification number,
the management server generates a singular transaction character for the customer account assigned to the customer,
selection of a payment method on the dealer system by the customer,
transmission of an authorization request for the transaction from the dealer system to the management server in the financial service provider system,
identification of the customer in the financial service provider system by entry, scanning or other transmission (e.g. by means of NFC) of the customer device identification number into or to the dealer system,
entry of the already generated transaction character into the dealer system and transmission of the transaction character to the management server,
checking and comparison of the customer-specific transaction identification number and of the singular transaction character sent from the dealer system to the management server,
execution of the transaction by the financial service provider after successfully checking the correspondence of the transaction data entered and provided by the dealer and the customer and sending a message on the successful execution of the transaction to the customer device and the dealer system.

Preferably, the transaction character directly or in encrypted form contains a designation of the customer, the dealer, the goods or services offered by the dealer, the dealer location and the amount of the financial transaction, and for example consists of a character string with numbers, letters and/or special characters or of a barcode, a matrix code (QR code) or a chart which is scanned from the dealer system with the customer device and sent to the management server in the financial service provider system.

Before a financial transaction monitored and executed by the financial service provider system a registration process takes place, in which the dealer system and the customer device are registered in the financial service provider system. The financial service provider system assigns an identification PIN to the customer device after a registration of the customer device with the financial service provider system by linking the customer device with personal, sensible data of the customer.

To facilitate the selection of the dealer, at which the desired goods or services are purchased, for the customer after entry of the identification number assigned to the customer device by the financial service provider system into the customer device, the geodata of the customer device are determined and the customer is asked by the financial service provider system to select a dealer from a list of proposed dealers sent from the financial service provider system to the customer device, or to confirm a dealer proposed by the financial service provider system, wherein the list of proposed dealers or the proposed dealer is determined by the financial service provider system with reference to the geodata of the customer device.

Alternatively, the customer can access to a dealer database listing a plurality of dealers and select a dealer listed therein.

Analogously, the financial service provider system can determine the geodata of the dealer system after the transmission of the authorization request for the transaction from the dealer system to the management server and store the same for a time period as dealer location (Point of Sale—POS).

Should the determination of the geodata of the dealer system or customer device fail, a direct coupling of dealer system and customer device can be carried out instead of a coupling of dealer and customer device via the management server in the financial service provider system, in that an authentification of the customer and dealer is effected by means of near field communication (NFC).

A system for executing a financial transaction by a financial service provider (Payment Service Provider—PSP), in which a mobile communication terminal of a customer (customer device) and a mobile or stationary communication system of a dealer (dealer system) are connected with a management server in a financial service provider system via a communication network, and for localizing the customer, is characterized by
means for entry of an identification number (PIN) assigned to the customer device by the financial service provider system into the customer device,
means for connecting the customer device with the financial service provider system after successfully checking the identification number assigned to the customer device,
means for selection of a dealer from a list of proposed dealers of the financial service provider system or for confirmation of a dealer proposed by the financial service provider system by the customer,
means for transmitting an authorization request for the transaction from the dealer system to the management server in the financial service provider system,
means for generation of a singular transaction character by a random generator connected with the management server in the financial service provider system and for sending the singular transaction character to the dealer system,
means for sending a request to the customer device to enter the transaction character sent to the dealer system into the customer device,
means for entering the transaction character into the customer device and sending the transaction character to the management server,
means for checking the transaction character sent from the customer device to the management server,
means for sending the transaction data to the customer device,
means for confirmation of the transaction data by the customer,
means for checking the correspondence of the transaction data confirmed by the customer with the transaction data communicated by the dealer to the financial service provider system, and
means for execution of the transaction by the financial service provider after successfully checking the correspondence of the transaction data entered by the dealer and the customer and for sending a message on the successful execution of the transaction to the customer device and the dealer system.

Alternatively, the system for executing a financial transaction by a financial service provides includes
means for entry of an identification number assigned to the customer device by the financial service provider system into the customer device,
means for selection of a payment method on the dealer system by the customer,
means for transmitting an authorization request for the transaction from the dealer system to the management server in the financial service provider system,
means for generation of a singular transaction character by a random generator connected with the management server in the financial service provider system and for sending the singular transaction character to the dealer system,
means for representation of the transaction character in complex in conjunction with an identification character of the dealer system,
means for entry or scanning of the transaction character and the unambiguous dealer system ID by the customer into the customer device and for transmission of the transaction character to the management server,
means for checking the transaction character sent from the customer device to the management server,
means for sending the transaction data to the customer device,
means for confirmation of the transaction data by the customer,
means for checking the correspondence of the transaction data confirmed by the customer with the transaction data communicated by the dealer to the financial service provider system, and
means for execution of the transaction by the financial service provider after successfully checking the correspondence of the transaction data entered by the dealer and the customer and sending a message on the successful execution of the transaction to the customer device and the dealer system.

Preferably, the customer device via a communication network formed as radio network and the dealer system via a communication network formed as radio network or stationary network are connected with the management server of the financial service provider system, which contains a random generator connected with the management server for generating a singular or complex transaction character for the financial transaction, wherein the management server of the financial service provider system is connected with the random generator, a payment processor server/network, a PCI DSS-secured server and a web application server via a local network.

While the customer device exclusively is formed as mobile phone or smartphone (Personal Digital Assistant—PDA) for mobile communication, the dealer system can consist either of a mobile phone or smartphone, which via a radio network are connectable with the management server of the financial service provider system, or of a point-of-sale terminal (POS terminal) with peripheral devices, wherein the peripheral devices can include a barcode reader, magnetic stripe reader, memory and/or printer. In addition, the dealer system can comprise a random generator for generating transaction data.

For a direct identification of customer device and dealer system, both can be provided with a device for near field communication (NFC).

With reference to several exemplary embodiments illustrated in the drawing the idea underlying the invention and the variation possibilities of the invention will be explained in detail. In the drawing:

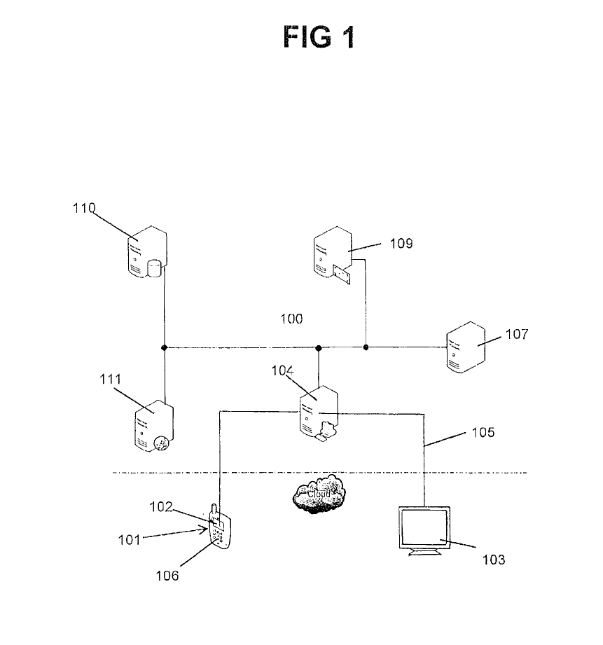

FIG. 1 shows a schematic representation of a system for executing a financial transaction by a financial service provider with authorization function;

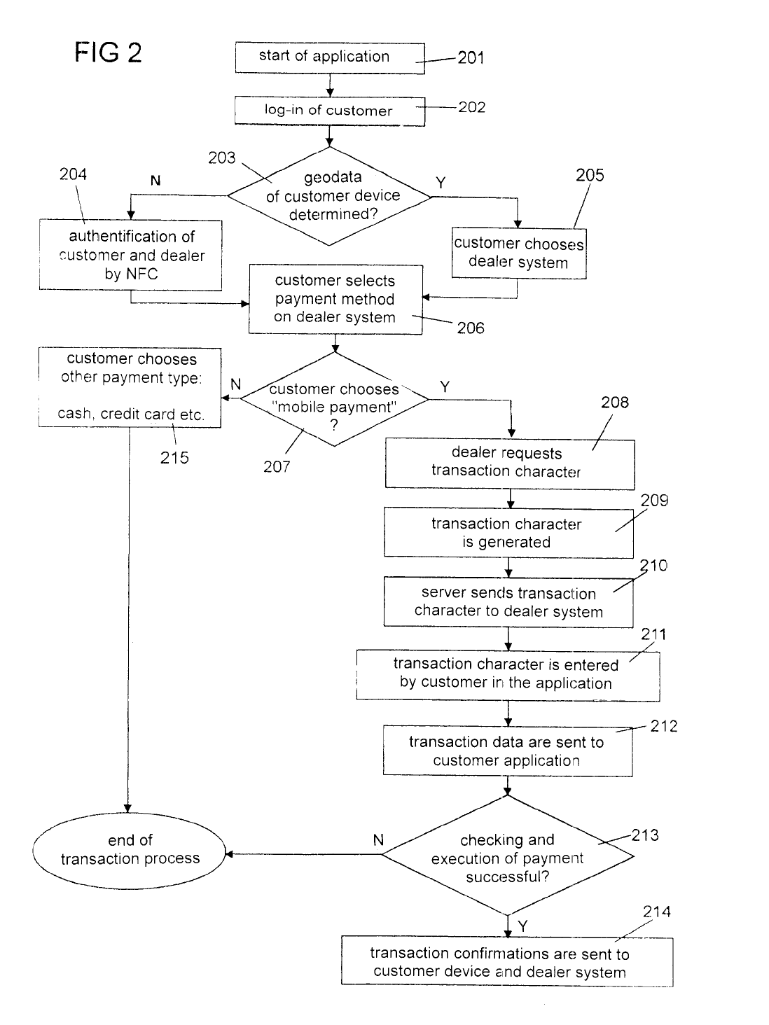

FIG. 2 shows a flow diagram of the course of an identification process of a customer with activation of the customer account on the part of the financial service provider;

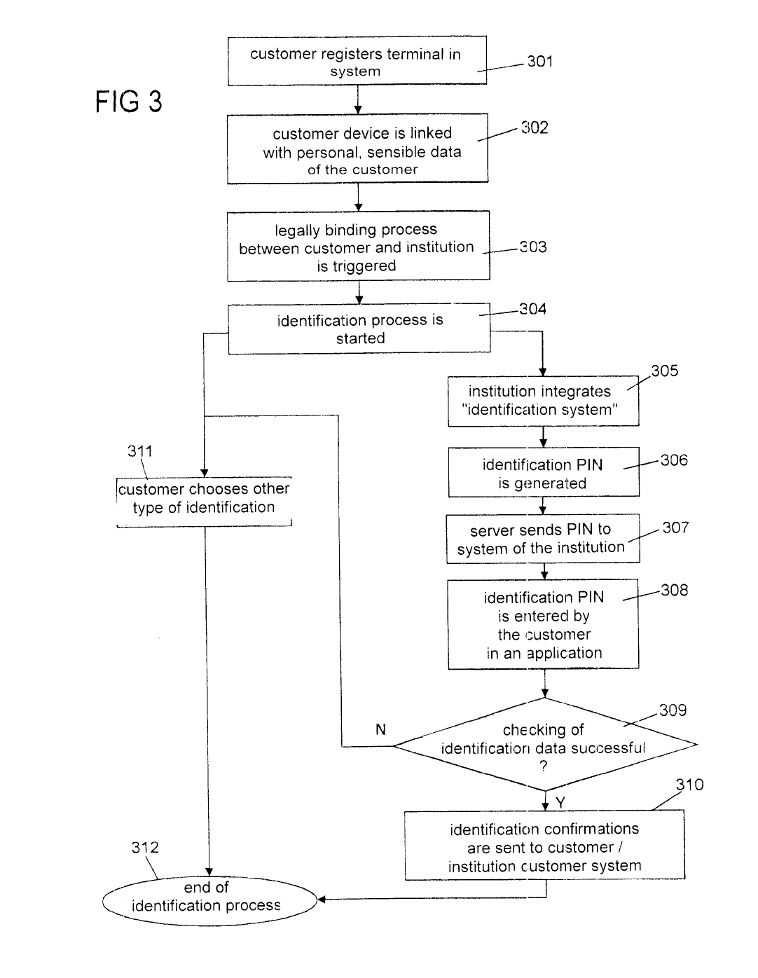

FIG. 3 shows a flow diagram of the course of a financial transaction with registration and activation of a customer device in the system of the financial service provider;

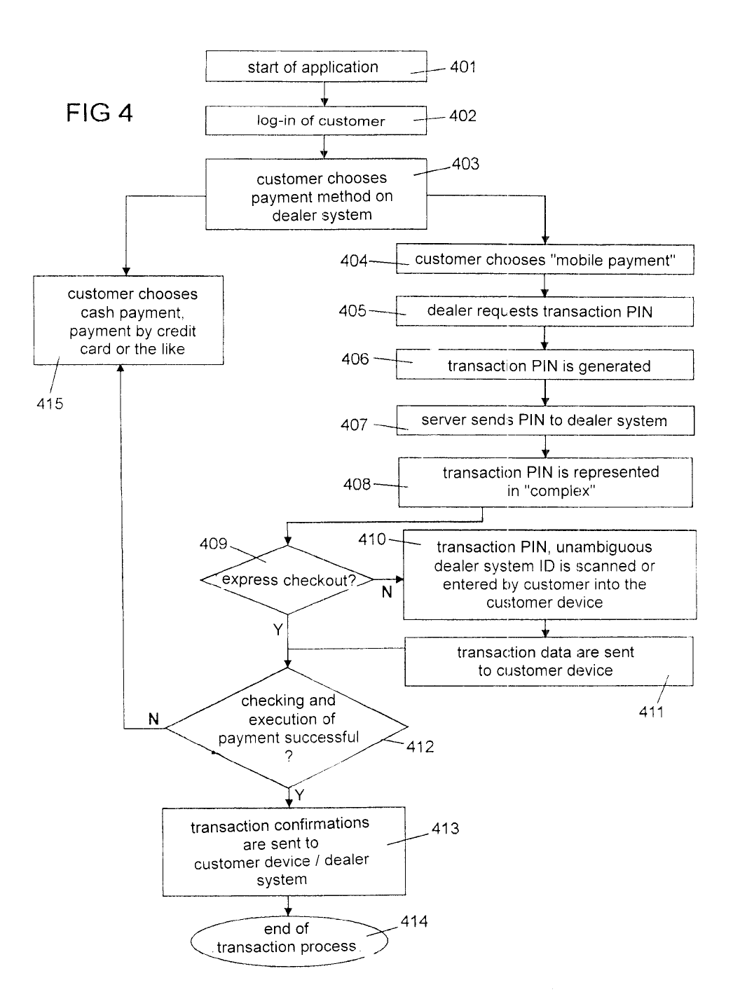

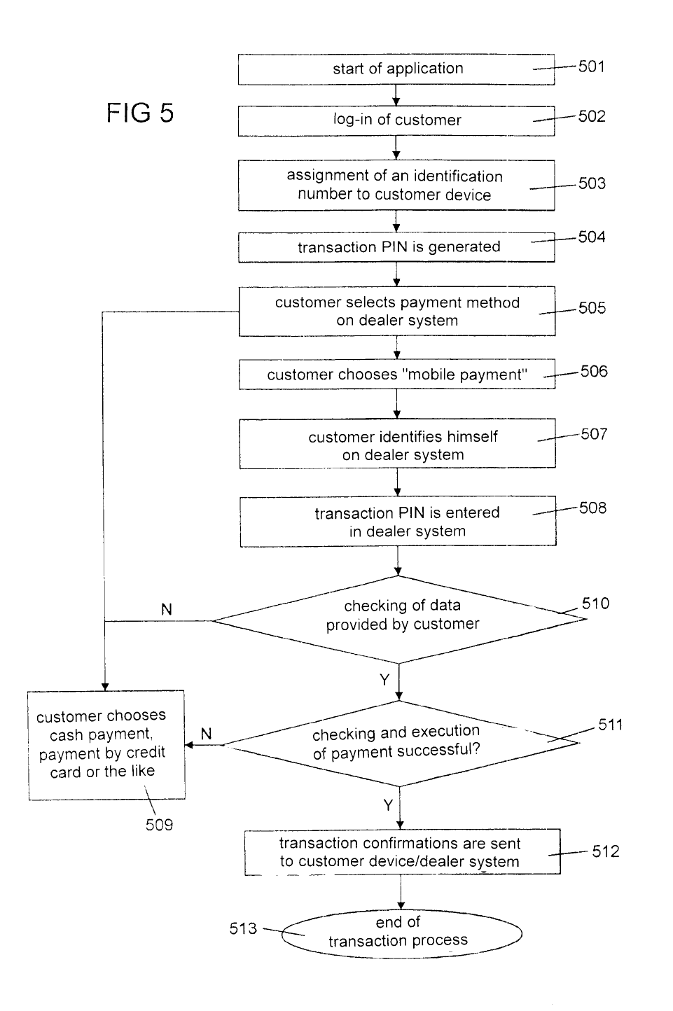

FIG. 4 shows a flow diagram of the course of a financial transaction with a complex transaction character and an express checkout;

FIG. 5 shows a flow diagram of the course of merging dealer and customer or dealer system and customer device, and for identifying the customer in the case of an offline transaction, and

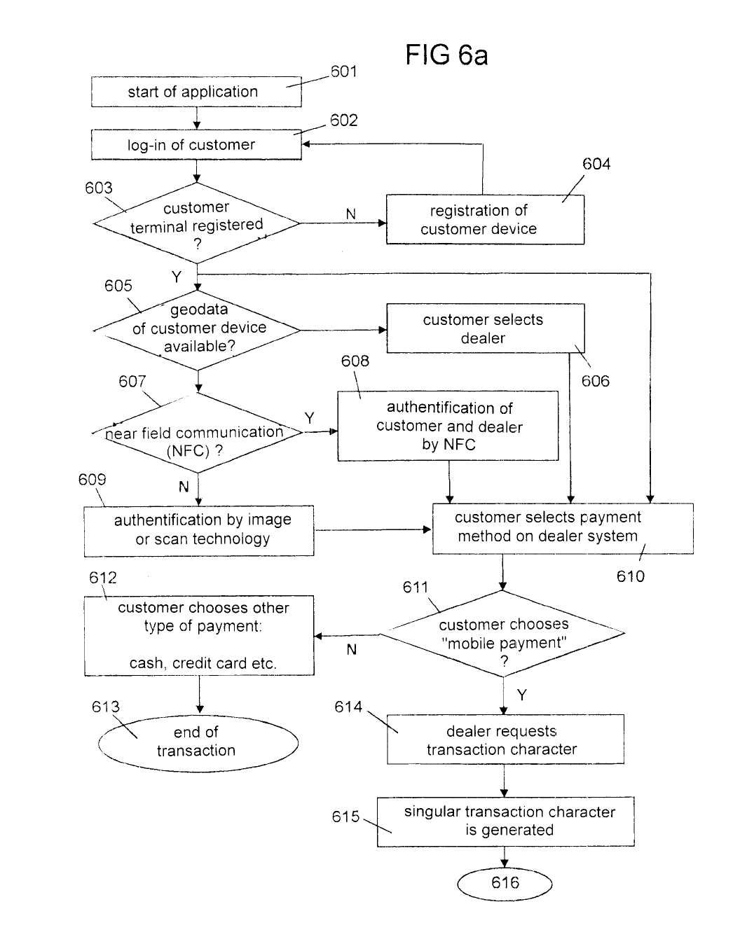

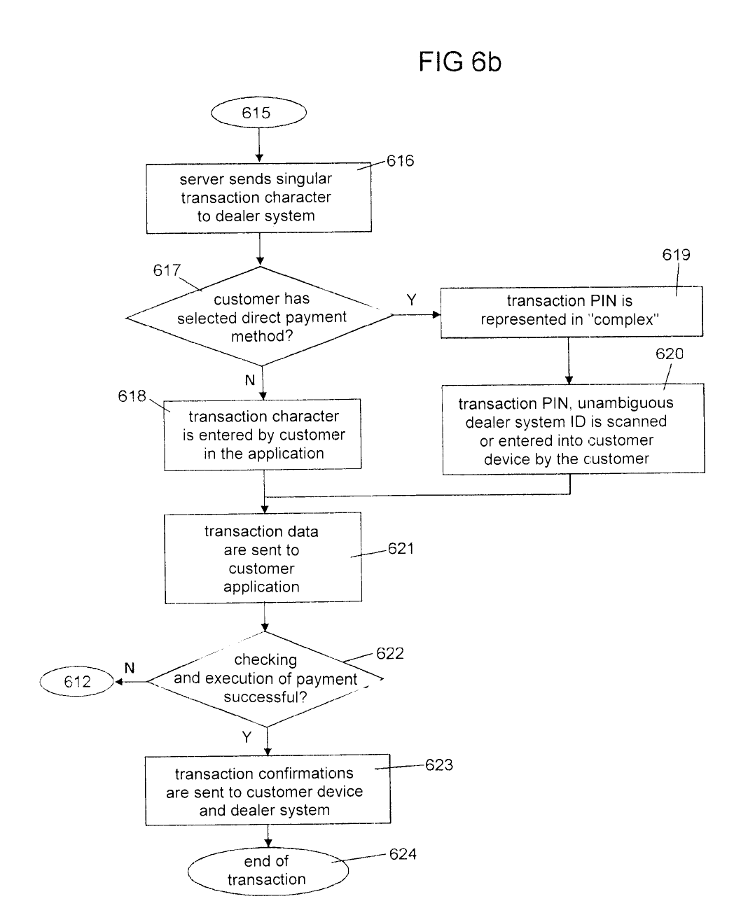

FIGS. 6a and 6b show flow diagrams of the course of a financial transaction combining the variants according to FIGS. 2 to 5.

The schematic representation of a system for executing a financial transaction by a financial service provider system with authorization function comprises a customer device 101 which consists of a mobile communication device, such as for example a mobile phone, a PDA or the like. The customer device 101 includes a screen 102 and a data input device 106, which can consist of a keyboard or a touch-sensitive screen, and is capable of exchanging data with a management server 104 of a financial service provider system 100 via a mobile radio network as communication network 105.

A dealer system 103 located at the dealer location (point of sales—POS) consists of a computer system, for example in the form of a checkout system, which in a mobile and/or stationary way is connectable with the communication network 105, for example the internet or a mobile radio network, and provides for a communication with the management server 104 of the financial service provider system 100. The dealer system 103 among other things has its “own” PIN generator and is formed as mobile or stationary communication device, which can consist of a mobile phone, a PDA or a point-of-sale terminal (POS terminal) with peripheral devices, such as barcode reader, magnetic stripe reader, memory, printer, a transmitting/receiving unit for near field communication (NFC) or the like. The dealer can operate a stationary or mobile shop, an internet commerce or a mail order business.

The customer device 101 and the dealer system 103 are connected with the management server 104 in the system 100 of the financial service provider via the communication network 105. The management server 104 in turn is connected with a random generator 107 via a local network (Local Area Network—LAN) 108 in the financial service provider system 100, wherein preferably a separate random generator 107 is associated to each dealer system 103.

The system of the financial service provider furthermore includes a payment processor server/network 109, a PCI DSS-secured server 110 and a web application server 111, which likewise are connected to the local network 108 of the financial service provider system 100.

The customer gains access to a network-based application offered by the financial service provider by entering a PIN (Personal Identification Number). The customer only gains access to and only can change sensible data such as credit card information and the like after having entered another password into the system 100 of the financial service provider, which satisfies higher safety standards than the PIN, for example by using capital and small letters, at least one digit, a maximum of three digits in a row, at least one symbol, and so on. After carrying out the PIN-based identification, the personal and sensible data of the customer are not accessible either during the payment operation.

The method for executing a financial transaction usually is initiated in that the customer brings a merchandise or service to a point of sale at the dealer location, which can be a cash desk, an electronic shopping cart in an online shop or the like. The dealer in the form of a cashier, a screen representation, a sales terminal facing the customer or the like starts the financial transaction by addition of the purchase prices of the purchased goods or services.

For executing the financial transaction, the application is started by the customer on the customer device in the first method step 201 according to FIG. 2, and in step 202 the customer is asked by the financial service provider system 100 to log in with a personal identification number (PIN). In step 203, a connection subsequently is made between the mobile customer device 101 and the management server 104 via the communication network 105, and the management server 104 determines the geodata of the customer device 101.

If the localization of the mobile customer device 101 fails, the customer can resort to near field communication (NFC), wherein by the singular allocation of an NFC chip to a specific customer account an unambiguous identification of the customer is ensured. Should the management server access to the NFC chip and be able to describe the same, a dynamic allocation of an identification number to a specific customer account also is conceivable. In addition, the management server 104 in the system of the financial service provider receives an inquiry from the NFC card reader of the dealer and thus also is able to unambiguously identify the dealer system 103.

Another possibility of merging the customer device 101 and the dealer system 103 for the financial transaction consists in the application of an image or scan technology, in which with the customer device 101 a scanner provided at the point of sale of the dealer location or an image displayed there is recorded by the customer device 101 and sent to the management server 104.

Should the management server 104 neither receive a geoinformation from the customer device 101 nor one of the aforementioned connections between customer device 101 and dealer system 103 can be made, the customer nevertheless is able to carry out a database query, provided that the customer device 101 has an internet connection, and to select the dealer at which he currently wants to pay.

If the customer device 101 does not have an internet connection for selecting the dealer, it furthermore is possible that the customer directly selects the desired payment method on the dealer system 103, so that a selection and identification of the dealer involved in the financial transaction is not required. An example for this will be described with reference to the flow diagram of FIGS. 4 and 5.

When the system of the financial service provider has detected the geodata of the customer device 101 and hence the current location of the customer device 101, it is able to generate a list of registered dealers, so that in the alternative step 205 the customer or user of the customer application can select the desired transaction partner or dealer from the list transmitted from the system of the financial service provider to the customer device 101. This list is generated from data which were queried during the registration process of the dealer. A selection of dealers in a specified radius around the determined geodata of the customer is offered to the customer. Alternatively, the customer confirms a dealer specified by the system of the financial service provider, when said dealer is the only dealer in the specified radius of the customer.

In step 206, the dealer subsequently asks the customer to select a payment method on the dealer system 103. Platforms such as point-of-sales software systems, internet shops and the like allow the customer to handle the payment operation. The selection is made by the customer on the dealer system 103 for example by pressing a button, touching a box of a touch-sensitive screen, by verbal communication with the dealer, or the like.

When the customer chooses the option “mobile payment” in step 207 and when the total sum of the purchased goods or services determined by the dealer is available, the dealer in method step 208 by means of the dealer system 103 sends an authorization request for the financial transaction via the communication network 105 to the management server 104 of the financial service provider system 100, wherein the authorization request can contain parts of the data or information concerning the transaction as well as a singular dealer identification character which is generated by the system of the financial service provider.

In step 209, the random generator 107 generates a singular transaction character for the respective financial transaction, which consists of numbers, letters, symbols or binary characters and combines the dealer identification character with geographic information, the date and the time of the financial transaction, so that it is valid only for the unique specific meeting of dealer and customer and for the specific transaction.

In step 210, the management server 104 sends the transaction character to the dealer system 103. In the following step 211, the customer is asked to enter the transaction character output to the dealer system 103 by the system of the financial service provider into his customer device 101. When the transaction character has successfully been entered into the customer device 101, the transaction data such as date, time, total amount of the purchased goods or services are sent to the customer device 101 in step 212 and the customer is asked to confirm the transaction data. In case the customer has deposited several bank accounts/credit cards and the like in the system, the customer now can select the desired type of payment and redeem possibly collected coupons, vouchers and the like.

In method step 213, the transaction process is initiated by the management server 104 in the financial service provider system, wherein the payment processor server 109 installed at the financial service provider makes use of various systems for estimating the transaction risk. After a successful check, the financial transaction is executed in method step 214 and the system of the financial service provider sends transaction confirmations to the customer device 101 and the dealer system 103.

When the transaction process has not been checked successfully, the customer like in the case of a rejection of the option “mobile payment” is asked in step 215 to choose another type of payment, such as for example cash payment, payment by means of a credit card, and the like. Both after sending the transaction confirmations to the dealer system 103 and the customer device 101 in method step 214 and after the request directed to the customer to select another type of payment in step 215, the transaction process is terminated in step 216.

The flow diagram shown in FIG. 3 of the course of an optional identification process of a customer with activation of the customer account at the financial service provider is started in method step 301 by registration of the mobile communication device of the customer (customer device 101) in the system of the financial service provider, in that the customer for example logs into the system of the financial service provider via a web surface. With the installation of a software component, for example an app (application) on the customer device, an unambiguous allocation of the customer device 101 to a specific customer user account can be ensured. In method step 302, the customer for this purpose enters sensible personal data such as biometric features of the person, the number of the passport or the like, into the web surface in the financial service provider system. These data will be linked with the respective customer device 101, provided that the same have been registered in the system of the financial service provider.

In method step 303, a legally binding agreement between the customer and an institute, for example a bank, is concluded, which requires the unambiguous identification. This can be e.g. a credit agreement or the like. In method step 304, the identification process is started, wherein the customer in principle can choose between various types of identification. This can be e.g. the personal “local” identification by means of signature, copy of the passport or the like, but also the so-called Post-Ident process of Deutsche Post.

In method step 305, the institute integrates the system of the financial service provider and after conclusion of the legally binding agreement between the customer and the institute, the customer chooses the system of the financial service provider. In method step 306, the management server 104 of the system of the financial service provider thereupon generates an identification PIN for this special identification process and in method step 307 sends the identification PIN to the financial institute, which communicates the identification PIN to the customer who in method step 308 enters the identification PIN into the software/application on his customer device for comparison.

In method step 309, the management server of the system of the financial service provider checks whether the data of the identification process actually correspond with the stored data of the customer and in method step 310 in case of success sends a success message to the systems involved or asks the customer to choose another identification system and terminates the identification process in method step 312.

To ensure an authentic linkage between the customer device, for example a smartphone, and the personal data of the customer, a network of independent identification centers is provided, which are made available by the financial service provider. In these identification centers special devices are set up, which collect e.g biometric data of the customer, take finger prints, make a copy of the passport etc. Subsequently, these data can be allocated to the customer device (smartphone or other computer-like system).

As “white-label” product, these data now can be provided by the financial service provider and be integrated into existing processes, so that they can be utilized in the identification process between various parties.

According to FIG. 3, different features thus already are read out in the identification process or during conclusion of an agreement depending on the institution and the requirements. By means of a webcam, institutes thus can compare e.g. biometric partial features with the data stored with the financial service provider. In addition, specific number blocks of the passport number or the like can be compared in connection with the conclusion of an agreement or an identification process. In dependence on the requirements of the offering institution and the existing technique, an extremely effective identification system thus can be integrated into partly existing infrastructures.

The flow diagram of the course of a financial transaction as shown in FIG. 4 without selection of the dealer involved in the financial transaction in conjunction with a complex transaction character and an express checkout starts with the method steps 401 to 403 analogous to the method steps 201, 202 and 206 of the course of a financial transaction as shown in FIG. 2 with authorization by the financial service provider system, in that the application is started by the customer on the customer device in the first method step 401 and in step 202 the customer is asked by the financial service provider system to log in with his personal identification number (PIN).

In method step 403 the customer selects the desired payment method directly on the dealer system. With the selection “mobile payment” in method step 404 the dealer system already hands over data of the shopping cart to the management server of the financial service provider. These data for example can be the price of article X, designation of article X, total price of the shopping cart and the like, wherein at least the total price must be handed over to the financial service provider system.

The following method steps 405 to 407 in turn correspond to the method steps 208 to 210 of the financial transaction described in conjunction with FIG. 2, in that in method step 405 the dealer sends an authorization request for the financial transaction via the communication network 105 to the management server 104 of the financial service provider system by means of the dealer system 103, and in step 406 the random generator 107 generates a singular transaction character for the respective financial transaction, which in step 408 is transmitted by the management server 104 to the dealer system 103. In method step 408, the transaction character together with a unique identification character of the dealer system is displayed on the dealer system in “complex”, for example as chart or matrix character (QR code) in scan technology.

The representation of the complex transaction and identification character on the dealer system thus is effected instead of method steps 203 to 205 of the financial transaction described in conjunction with FIG. 2 and serves the customer-friendliness, so that an authentification by means of near field communication also can be omitted, which requires certain hardware components on the part of the customer device. By using charts, matrix characters and scan technologies it is also possible to transmit longer and unambiguous identification characters of the dealer systems to the customer. These complex transaction and identification characters contain further information beside the singular transaction character.

Since the transaction character communicated to the dealer system in method step 405 contains the data of the financial transaction sent from the dealer system to the financial service provider system, i.e. at least the total amount of the shopping cart desired by the customer, and the data manually entered or scanned in by the customer with the complex transaction and identification character also contain the identification character of the dealer system beside the transaction character generated by the financial service provider system and sent to the dealer system, the customer can choose an “express checkout” offered by the dealer in method step 409, in which the customer and the dealer still can use the advantages of a possible offline transaction and the financial transaction is enabled at a later point in time and up to this time is “blocked” in the customer device, while the dealer system still is able to communicate with the system of the financial service provider.

In an offline transaction
a credit line is fixed for the customer,
the credit line available for the customer is updated at specified intervals and stored in encrypted form in the background of the customer application,
the dealer offers the express checkout to the customer during the identification and transaction process,
the application in the background checks the customer account, as to whether the current credit line is sufficient for the transaction,
the application outputs a success or error message to the dealer system, which should be displayed to the dealer and be confirmed by the same in the customer device, and
the transaction is executed as soon as the customer device again gets into connection with the management server of the system of the financial service provider.

After method step 408, the unambiguousness of the customer or dealer requests and transmission of information is given, as to each system and device involved in the transaction and identification process a specific identification character is allocated. In method step 410, the customer thus can enter the minimum of information by manual entry of the transaction character and the identification character of the dealer system or by read-out by means of camera/scan technology by means of the customer device 101, when no express checkout is desired or offered by the dealer.

Hence, the customer device 101 has been linked with the dealer system 103, and the management server 104 can unambiguously allocate the data of the transaction received in method step 405 with the request of the dealer, send the transaction data to the customer device 101 in method step 411, and request a confirmation of the transaction on the customer device 101.

In method step 413, the transaction process is initiated by the management server 104 in the financial service provider system, wherein the payment processor server 109 installed at the financial service provider makes use of various systems for estimating the transaction risk. After a successful check, the financial transaction is executed, and in method step 413 the system of the financial service provider sends transaction confirmations to the customer device 101 and the dealer system 103.

When the transaction process has not been checked successfully, the customer like in the case of a rejection of the option “mobile payment” is asked in step 416 to choose another type of payment, such as for example cash payment, payment by means of a credit card, and the like. Both after sending the transaction confirmations to the dealer system 103 and the customer device 101 in method step 413 and after the request directed to the customer to select another type of payment in step 415, the transaction process is terminated in step 414.

The flow diagram of the course of a financial transaction in stationary trade as shown in FIG. 5, which on the customer side can be executed in the offline mode, starts with the method steps 501 to 502 analogous to the method steps 201, 202 and 401, 402 of the course of a financial transaction with authorization by the financial service provider system as shown in FIG. 2 and FIG. 4 in that in the first method step 501 the application is started by the customer on the customer device 101 and in step 502 the customer is asked by the financial service provider system to log in with his personal identification number (PIN).

In method step 503, a transaction identification number is assigned to the customer device. The same can be static, but also dynamic and can consist of numbers, letters, symbols or binary characters. In the case of the dynamic assignment, an additional random generator is assigned to each customer device.

In method step 504, a singular transaction character is generated already before the transaction process and allocated to the customer. To ensure an increased degree of safety, these customer-specific, singular transaction characters can be updated and exchanged in dependence on time. Furthermore, the two separately acting systems of the generation of the dynamic transaction identification number of the customer and the dynamic system of the generation of singular transaction characters provide an additional degree of safety.

In method step 505 the customer selects the desired payment method directly on the dealer system 103. With the selection “mobile payment” in method step 506 the dealer system already hands over data of the shopping cart to the management server of the financial service provider. These data for example can be the price of article X, designation of article X, total price of the shopping cart and the like, wherein at least the total price must be handed over to the financial service provider system.

In the following method steps 507 and 508, the customer first has to identify himself with the financial service provider system via the dealer system in method step 507. The entry of the customer-specific transaction identification number is made by the customer on the dealer system 103 for example by pressing a button, touching a box of a touch-sensitive screen, by verbal communication with the dealer, or the like. Furthermore, it is conceivable that a QR code, barcode scanner, an NFC receiving unit or the like of the dealer system 103 reads out the customer-specific transaction identification number from the customer device 101 and transmits the same to the financial service provider system.

Hence, the customer device 101 has been linked with the dealer system 103 and the management server 104 can unambiguously allocate the transaction data received in method step 507 with the request of the dealer.

In method step 508, the customer now is asked to provide the singular transaction character already generated for him to the dealer system. The entry can be made by pressing a button, touching a box of a touch-sensitive screen, by verbal communication with the dealer, or the like. The management server receives this information and in method step 510 now can compare whether the singular transaction character entered corresponds with the transaction identification number of the customer. When the transaction data have not been checked and compared successfully, the customer like in the case of a rejection of the option “mobile payment” is asked in step 509 to choose another type of payment, such as for example cash payment, payment by means of a credit card, and the like.

In method step 511, the transaction process is initiated by the management server 104 in the financial service provider system, wherein the payment processor server 109 installed at the financial service provider makes use of various systems for estimating the transaction risk. After a successful check, the financial transaction is executed, and in method step 512 the system of the financial service provider sends transaction confirmations to the customer device 101 and the dealer system 103.

When the transaction process has not been checked successfully, the customer like in the case of a rejection of the option “mobile payment” is asked in step 509 to choose another type of payment, such as for example cash payment, payment by means of a credit card, and the like. Both after sending the transaction confirmations to the dealer system 103 and the customer device 101 in method step 512 and after the request directed to the customer to select another type of payment in step 509, the transaction process is terminated in step 513.

With reference to a flow diagram, FIGS. 6a and 6b show the course of a financial transaction which comprises a part of the identification and transaction processes described with reference to FIGS. 2 to 4.

After the start of the application in method step 601, the customer logs into the system of the financial service provider in method step 602 and is asked by the financial service provider system to log in with a personal identification number (PIN). The financial service provider system checks whether the customer device is registered in the system and the PIN can be allocated to the customer device. If this is not the case (N), the customer device can be registered in the system in method step 604 and be linked with personal data, during the transaction process e.g. with information on the bank account, on the credit card and the like. The process shown in the flow diagram of FIG. 3 is a possible option of the registration and linkage of personal data with the customer device, e.g. a smartphone. Subsequently, the customer can log in with the assigned PIN.

When the customer device is registered in the system (Y), the customer can directly select a payment method in the dealer system and jump to method step 610. Otherwise, the system of the financial service provider in method step 605 checks whether geodata of the customer device are available. If this is the case (Y), the geodata of the customer device are gathered, so that the current location of the customer device is detected and used for making a list of registered dealers. In method step 606, the customer or user of the customer application then can select the desired transaction partner or dealer from the list transmitted from the system of the financial service provider to the customer device. A selection of dealers in a specified radius around the determined geodata of the customer is offered to the customer, or the customer alternatively is asked to confirm a dealer specified by the system of the financial service provider, when this is the only dealer in the specified radius of the customer.

When no geodata of the customer device are to be determined by the system of the financial service provider (N), the customer can resort to near field communication (NFC) in method step 607, wherein in the case of success (Y) an unambiguous identification of the customer is ensured by the singular allocation of an NFC chip to a specific customer account. In addition, in method step 608 the management server 104 in the system of the financial service provider receives an inquiry from the NFC card reader of the dealer and thus also is able to unambiguously identify the dealer system 103.

When near field communication (NFC) is not possible either (N after method step 607), an authentification of the customer and dealer by a database provided by the financial service provider or the application of an image or scan technology can be effected, in which with the customer device a scanner provided at the point of sale of the dealer location or an image displayed there is recorded by the customer device and in method step 609 sent to the management server of the financial service provider system.

After corresponding linkage of the customer device and dealer system by determination of the geodata, near field communication, selection of the dealer system in a provided database, by means of image or scan technology or by direct access of the customer to the dealer system, the dealer requests the customer in step 610 to select a payment method on the dealer system by pressing a button, touching a box of a touch-sensitive screen, by verbal communication with the dealer, or the like.

When the customer chooses the option “mobile payment” (output Y in method step 611) and the total sum of the purchased goods or services determined by the dealer is available, the dealer in method step 614 sends an authorization request for the financial transaction and a request for a transaction character to the management server of the financial service provider system.

When the customer rejects the option “mobile payment” (output N in method step 611) and instead chooses the option “other type of payment” such as cash payment or payment by credit card, he is asked to make the chosen type of payment in method step 612 and the application is terminated in method step 613. The offer of an offline transaction is the sole responsibility of the offering dealer or the financial service provider.

In method step 615 a singular transaction character for the respective financial transaction is generated in the system of the financial service provider and in method step 616 sent to the dealer system.

In method step 617, the dealer offers a direct payment method to the customer. When the customer does not select the direct payment method in the dealer system (output N), the customer is asked in method step 618 to enter the transaction character output to the dealer system by the system of the financial service provider into his customer device. When the customer, however, has chosen the direct payment method in the dealer system (output Yin step 617), a complex representation of the transaction character in combination with an identification character of the dealer system is generated by the dealer system in method step 619, and in method step 620 the customer is asked to scan or manually enter the complex transaction character output to the dealer system as graphical symbol or matrix code into the application of the customer device.

When the singular or complex transaction character has successfully been entered into the customer device, the transaction data such as date, time, total amount of the purchased goods or services are sent to the customer device in method step 621 and the customer is asked to confirm the transaction data. In this step, the customer can select the desired type of payment and possibly redeem collected coupons, vouchers and the like.

In method step 622, the transaction process is checked by the management server in the financial service provider system and when it has been checked successfully (output Y in method step 622), the financial service provider system executes the financial transaction in method step 623, sends transaction confirmations to the customer device and the dealer system, and terminates the transaction in step 624.

When the transaction process has not been checked successfully (output N in method step 622), the customer in the case of a rejection of the option “mobile payment” is asked in step 612 to choose another type of payment, such as for example cash payment, payment by means of a credit card, and the like.

### LIST OF REFERENCE NUMERALS

100 financial service provider system
101 customer device
102 screen
103 dealer system
104 management server of the financial service provider system
105 communication network
106 data input device
107 random generator
108 local network (Local Area Network—LAN)
109 payment processor server/network
110 PCI DSS-secured server
111 web application server

### LEGEND FOR FIGS. 6A AND 6B

601 Start of the application
602 Log-in of the customer
603 Customer terminal registered in the system?
604 Customer terminal is registered in the system and linked with personal, sensible data (in the transaction process: information on bank account, credit card)
605 Geodata available?
606 Customer chooses dealer
607 Near field communication (NFC)?
608 Authentification of customer and dealer by NFC
609 Authentification of customer and dealer by image/scan technology is effected after selection of the payment type “mobile payment” at a later point in time
610 Customer selects payment method on dealer system
611 Customer chooses mobile payment?
612 Customer chooses other type of payment: cash, credit card etc.
613 End of transaction
614 Dealer requests transaction character
615 Singular transaction character is generated
616 Server sends singular transaction character to dealer
617 Has the customer selected the payment method on the dealer system?
618 Customer enters singular transaction character into application
619 Complex transaction character with dealer ID is generated
620 Complex transaction character is scanned or entered into the application by the customer
621 Transaction data are sent to customer application
622 Checking and execution of the payment successful?
623 Transaction confirmations are sent to customer and dealer system
624 End of transaction

1. A method for executing a financial transaction, in which a mobile communication terminal of a customer (customer device 101) and a mobile or stationary communication system of a dealer (dealer system 103) are connected via a communication network (105), wherein
the customer device (101) and the dealer system (103) are connected with a management server (104) of a financial service provider system (100) of a financial service provider (Payment Service Provider—PSP) in which the dealer system (103) is registered and an identification number (PIN) is assigned to the customer (101),
transaction data and an authorization request for the transaction are transmit-ted from the dealer system (103) to the management server (104) in the financial service provider system (100) and a transaction character is generated by a random generator (107) connected with the management server (104) in the financial service provider system (100) and is sent to the dealer system (103),
and the transaction character entered into the customer device (101) upon re-quest of the financial service provider system (100) is forwarded to the management server (104), checked by the management server (104) and in case of correspondence with the transaction character sent to the dealer system (103) the transaction data are transmitted to the customer device (101) for checking and approval.

2. The method according to claim 1, wherein the dealer system (103) is registered in the financial service provider system (100), that an identification number (PIN) is assigned to the customer device (101) by the financial service provider system (100), which before transmission of the transaction character from the financial service provider system (100) to the customer device (101) is checked for its validity by the financial service provider system (100).

3. The method according to claim 1, wherein the financial transaction comprises the following steps:
input of an identification number (PIN) assigned to the customer device (101) by the financial service provider system (100) into the customer device (101),
connecting the customer device (101) with the financial service provider system (100) after successfully checking the identification number assigned to the customer device (101),
selection of a dealer by the customer,
transmission of an authorization request for the transaction from the dealer system (103) to the management server (104) in the financial service provider system (100),
generation of a singular transaction character by the random generator (107) connected with the management server (104) in the financial service provider system (100) and sending the singular transaction character to the dealer system (103),
sending a request to the customer device (101) to enter the transaction character sent to the dealer system (103) into the customer device (101),
entry of the transaction character into the customer device (101) and transmission of the transaction character to the management server (104),
checking the transaction character sent from the customer device (101) to the management server (104),
sending the transaction data to the customer device (101),
confirmation of the transaction data by the customer,
checking the correspondence of the transaction data confirmed by the customer with the transaction data transmitted by the dealer to the financial service provider system (100), and
execution of the transaction by the financial service provider after successfully checking the correspondence of the transaction data entered by the dealer and the customer and sending a message on the successful execution of the transaction to the customer device (101) and the dealer system (103).

4. The method according to claim 1, wherein the financial transaction comprises the following steps:
entry of an identification number (PIN) assigned to the customer device (101) by the financial service provider system (100) into the customer device (101),
selection of a payment method on the dealer system by the customer,
transmission of an authorization request for the transaction from the dealer system (103) to the management server (104) in the financial service provider system (100),
generation of a singular transaction character by the random generator (107) connected with the management server (104) in the financial service provider system (100) and sending the singular transaction character to the dealer system (103),
representation of the transaction character in complex in conjunction with an identification character of the dealer system (103),
entry or scanning of the transaction character and the unambiguous dealer system ID by the customer into the customer device (101) and transmission of the transaction character to the management server (104),
checking the transaction character sent from the customer device (101) to the management server (104),
sending the transaction data to the customer device (101),
confirmation of the transaction data by the customer,
checking the correspondence of the transaction data confirmed by the customer with the transaction data transmitted by the dealer to the financial service provider system (100), and
execution of the transaction by the financial service provider after successfully checking the correspondence of the transaction data entered by the dealer and the customer and sending a message on the successful execution of the transaction to the customer device (101) and the dealer system (103).

5. The method according to claim 4, wherein the dealer offers an express checkout to the customer, in which the financial transaction is enabled at a later point in time and up to this time is blocked in the customer device and the dealer system still communicates with the system of the financial service provider.

6. The method according to claim 1, wherein the transaction character directly or in encrypted form contains a designation of the customer, of the dealer, of the goods or services offered by the dealer, the dealer location and the amount of the financial transaction.

7. The method according to claim 6, wherein the transaction character consists of a string of characters with numbers, letters and/or special characters to be entered into the customer device (101).

8. The method according to claim 6, wherein the transaction character consists of a bar code, a matrix code (QR code) or a chart which by means of the customer device (101) is scanned from the dealer system (103) and sent to the management server (104) in the financial service provider system (100).

9. The method according to claim 1, wherein the financial service provider assigns an identification number to the customer device (101) after registration of the customer device (101) in the financial service provider system (100) by linking the customer device (101) with personal, sensible data of the customer.

10. The method according to claim 1, wherein the dealer system (103) and the customer device (101) are registered in the financial service provider system (100).

11. The method according to claim 1, wherein after entry of the identification number assigned to the customer device (101) by the financial service provider system (100) into the customer device (101), the geodata of the customer device (101) are determined and the customer is asked by the financial service provider system (100) to select a dealer from the list of proposed dealers sent from the financial service provider system (100) to the customer device (101) or to confirm a dealer proposed by the financial service provider system (100), and wherein the list of proposed dealers or the proposed dealer are determined by the financial service provider system (100) with reference to the geodata of the customer device (101).

12. The method according to claim 1, wherein after the transmission of the authorization request for the transaction from the dealer system (103) to the management server (104) the financial service provider system (100) determines the geodata of the dealer system (103) and stores the same for a time period as dealer location (Point of Sale—POS).

13. The method according to claim 1, wherein in the case of non-determinable geodata of the customer device (101) and/or the dealer system (103) an authentification of the customer and dealer is effected by means of near field communication (NFC).

14. The method according to claim 1, wherein the customer selects a dealer
from a list of proposed dealers of the financial service provider system (100), which was sent to the customer device (101),
by confirming a dealer proposed by the financial service provider system (100), or
from a dealer database listing a plurality of dealers.

15. The method according to claim 1, wherein for merging dealer system and customer device and for identifying the customer during an offline transaction the following method steps are carried out:
entry of a customer device identification number assigned to the customer device (101) by the financial service provider system (100) into the customer device,
the management server (104) of the financial service provider system (100) assigns a static or dynamic transaction identification number to the customer device (101),
the management server (104) generates a singular transaction character for the customer account assigned to the customer,
selection of a payment method on the dealer system (103) by the customer,
transmission of an authorization request for the transaction from the dealer system (103) to the management server (104) in the financial service provider system (100),
identification of the customer in the financial service provider system (100) by entry, scanning or other transmission, for example by means of NFC, of the customer device identification number into or to the dealer system (103),
entry of the previously generated transaction character into the dealer system (103) and transmission of the transaction character to the management server (104),
checking and comparison of the customer-specific transaction identification number and of the singular transaction character sent from the dealer system (103) to the management server (104), and
execution of the transaction by the financial service provider after successfully checking the correspondence of the transaction data entered and provided by the dealer and the customer and sending a message on the successful execution of the transaction to the customer device (101) and the dealer system (103).

16. A system for executing a financial transaction according to claim 1, comprising
means for entering an identification number (PIN) assigned to the customer device (101) by the financial service provider system (100) into the customer device (101),
means for connecting the customer device (101) with the financial service provider system (100) after successfully checking the identification number assigned to the customer device (101),
means for selecting a dealer,
means for transmitting an authorization request for the transaction from the dealer system (103) to the management server (104) in the financial service provider system (100),
means for generating a singular transaction character by the random generator (107) connected with the management server (104) in the financial service provider system (100) and sending the singular transaction character to the dealer system (103),
means for sending a request to the customer device (101) to enter the transaction character sent to the dealer system (103) into the customer device (101),
means for entering the transaction character into the customer device (101) and for transmitting the transaction character to the management server (104),
means for checking the transaction character sent from the customer device (101) to the management server (104),
means for sending the transaction data to the customer device (101),
means for confirmation of the transaction data by the customer,
means for checking the correspondence of the transaction data confirmed by the customer with the transaction data transmitted by the dealer to the financial service provider system (100), and
means for execution of the transaction by the financial service provider after successfully checking the correspondence of the transaction data entered by the dealer and the customer and sending a message on the successful execution of the transaction to the customer device (101) and the dealer system (103).

17. A system for executing a financial transaction according to claim 1, comprising
means for entering an identification number (PIN) assigned to the customer device (101) by the financial service provider system (100) into the customer device (101),
means for selecting a payment method on the dealer system by the customer,
means for transmitting an authorization request for the transaction from the dealer system (103) to the management server (104) in the financial service provider system (100),
means for generation of a singular transaction character by the random generator (107) connected with the management server (104) in the financial service provider system (100) and for sending the singular transaction character to the dealer system (103),
means for representation of the transaction character in complex in conjunction with an identification character of the dealer system (103),
means for entering or scanning the transaction character and the unambiguous dealer system ID by the customer into the customer device (101) and for transmitting the transaction character to the management server (104),
means for checking the transaction character sent from the customer device (101) to the management server (104),
means for sending the transaction data to the customer device (101),
means for confirmation of the transaction data by the customer,
means for checking the correspondence of the transaction data confirmed by the customer with the transaction data transmitted by the dealer to the financial service provider system (100), and
means for execution of the transaction by the financial service provider after successfully checking the correspondence of the transaction data entered by the dealer and the customer and sending a message on the successful execution of the transaction to the customer device (101) and the dealer system (103).

18. The system according to claim 16, wherein the customer device (101) via a communication network (105) formed as radio network and the dealer system (103) via a communication network (105) formed as radio network or stationary network are connected with the management server (104) of the financial service provider system (100), which contains a random generator (107) connected with the management server (104) for generating a singular or complex transaction character for the financial transaction.

19. The system according to claim 18, wherein the management server (104) of the financial service provider system (100) is connected with the random generator (107), a payment processor server/network (109), a PCI DSS-secured server (110) and a web application server (111) via a local network (108).

20. The system according to claim 18, wherein the dealer system (103) consists of a mobile phone or a smartphone (Personal Digital Assistant—PDA), which via a radio network is connectable with the management server (104) of the financial service provider system (100).

21. The system according to claim 18, wherein the dealer system (103) consists of a point-of-sale terminal (POS terminal) with peripheral devices, in particular with a bar code reader, magnetic stripe reader, memory and/or printer.

22. The system according to claim 16, wherein the dealer system (103) contains a random generator.

23. The system according to claim 16, wherein the customer device (101) and the dealer system (103) are provided with a device for near field communication (NFC).

24. The system according to claim 17, wherein the customer device (101) via a communication network (105) formed as radio network and the dealer system (103) via a communication network (105) formed as radio network or stationary network are connected with the management server (104) of the financial service provider system (100), which contains a random generator (107) connected with the management server (104) for generating a singular or complex transaction character for the financial transaction.

25. The system according to claim 24, wherein the management server (104) of the financial service provider system (100) is connected with the random generator (107), a payment processor server/network (109), a PCI DSS-secured server (110) and a web application server (111) via a local network (108).

26. The system according to claim 24, wherein the dealer system (103) consists of a mobile phone or a smartphone (Personal Digital Assistant—PDA), which via a radio network is connectable with the management server (104) of the financial service provider system (100).

27. The system according to claim 24, wherein the dealer system (103) consists of a point-of-sale terminal (POS terminal) with peripheral devices, in particular with a bar code reader, magnetic stripe reader, memory and/or printer.

28. The system according to claim 17, wherein the dealer system (103) contains a random generator.

29. The system according to claim 17, wherein the customer device (101) and the dealer system (103) are provided with a device for near field communication (NFC).
